(19) United States
(12) Patent Application Publication
(10) Pub. No.: US 2012/0070072 A1
(43) Pub. Date: Mar. 22, 2012

(54) IMAGE PROCESSING DEVICE, IMAGE PROCESSING METHOD AND COMPUTER READABLE PRODUCT

(75) Inventors: Mayumi Yuasa, Tokyo (JP); Miki Yamada, Kanagawa (JP); Osamu Yamaguchi, Kanagawa (JP)

(73) Assignee: KABUSHIKI KAISHA TOSHIBA, Tokyo (JP)

(21) Appl. No.: 13/235,669

(22) Filed: Sep. 19, 2011

Related U.S. Application Data
(63) Continuation of application No. PCT/JP2009/059454, filed on May 22, 2009.

(51) Int. Cl. G06K 9/00

(52) U.S. Cl. 382/154

(57) ABSTRACT

According to one embodiment, an image processing device includes a readiness determining unit configured to determine whether or not a state of a face image included in an image at one time out of images obtained at a plurality of different times is a ready state that satisfies a condition for performing three-dimensionality determination, three-dimensionality determination is determining whether the object is three-dimensional or not; an initiation determining unit configured to determine whether or not a state of a face image included in an image at different time from the image at the one time is an initiation state changed from the ready state; and a first three-dimensionality determining unit configured to perform the three-dimensionality determination on the face images included in the images when it is determined that the state is the initiation state.

### CROSS-REFERENCE TO RELATED APPLICATIONS

This application is a continuation of PCT international application Ser. No. PCT/JP2009/059454 filed on May 22, 2009 which designates the United States; the entire contents of which are incorporated herein by reference.

### FIELD

The present invention relates to image processing.

### BACKGROUND

There have conventionally been techniques for determining impersonation by using obtained face images.

JP-A 2006-330936 (KOKAI) discloses a face recognition technique for determining that images of a face which are extracted from images of a plurality of frames and in which an eye region and a mouth region move in the same manner are impersonation images using photograph images or the like.

JP-A 2007-304801 (KOKAI) discloses a technique of detecting facial feature points from two face images with different orientations of the captured face, and determining whether or not the shape formed by the facial feature points is three-dimensional.

In the technique of JP-A 2006-330936 (KOKAI), however, only two-dimensional information is utilized, and it is thus difficult to distinguish between a photograph and a three-dimensional object in principle. On the other hand, the technique of JP-A 2007-304801 (KOKAI) may result in false-positive determination that the shape formed by the facial feature points is not a three-dimensional object depending on the position of the captured face images, the posture of a person or the like.

### BRIEF DESCRIPTION OF THE DRAWINGS

FIG. 1 is a block diagram illustrating a configuration of an image processing device according to a first embodiment;

FIG. 2 is a flowchart illustrating an operation of the image processing device;

FIG. 3 is a block diagram illustrating a configuration of an image processing device according to a second embodiment; and

FIG. 4 is a diagram illustrating a hardware configuration of a computer system.

### DETAILED DESCRIPTION

In general, according to one embodiment, an image processing device includes a readiness determining unit configured to determine whether or not a state of a face image included in an image at one time out of images obtained at a plurality of different times is a ready state that satisfies a condition for performing three-dimensionality determination, three-dimensionality determination is determining whether the object is three-dimensional or not; an initiation determining unit configured to determine whether or not a state of a face image included in an image at different time from the image at the one time is an initiation state changed from the ready state; and a first three-dimensionality determining unit configured to perform the three-dimensionality determination on the face images included in the images when it is determined that the state is the initiation state.

Various embodiments will be described hereinafter with reference to the accompanying drawings.

### First Embodiment

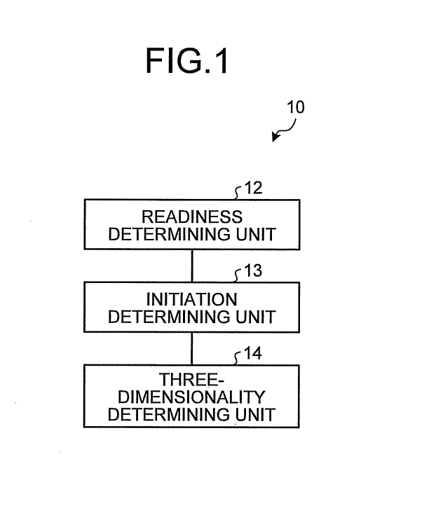

FIG. 1 is a block diagram illustrating a configuration of an image processing device 10 according to a first embodiment.

A readiness determining unit 12 determines whether or not a state of a face image included in an image at one time out of a plurality of images captured at different times by an image input unit 55, which will be described later, satisfies conditions for three-dimensionality determination. The readiness determining unit 12 determines whether or not a state of a face image included in an image at another time that is different from the image at the one time is a ready state. The readiness determining unit 12 may determine a state to be a “ready state” when all of the following three conditions are satisfied, for example. However, the present invention is not limited thereto, and a state may be determined to be a “ready state” when at least one of the following three conditions is satisfied.

Condition 1: The size of the face is within a set range.

Condition 2: The face orientation is within a set range including the frontal orientation.

Condition 3: The amount of motion of the face is within a set range (stationary).

The readiness determining unit 12 detects facial feature points from the images obtained by the image input unit 55 so as to determine whether the images are in a ready state. The readiness determining unit 12 can detect the feature points by using a method disclosed in

“Automatic facial feature point detection for face recognition from a single image”, Yuasa et al., Technical Report of the Institute of Electronics, Information, and Communication Engineers, PRMU2006-222, pp.5-10, February 2007, for example. Processes of determining whether conditions 1 to 3 are satisfied by using the feature points performed by the readiness determining unit 12 will be described below.

For determination of the condition 1, a distance between the center points of pupils, for example, out of the detected feature points is measured, and it is determined whether or not the distance is within a predetermined range, for example.

Determination of the condition 2 is made by measuring the face orientation using the detected feature points and determining whether the orientation is close to the frontal orientation with respect to the image input unit 55, for example. For the measurement of the face orientation, a method disclosed in JP-A 2003-141551 (KOKAI) may be used, for example.

The three-dimensional shape may be obtained from input moving images by using the factorization method disclosed in “Shape and motion from image streams under orthography: a factorization method,” C. Tomasi and T. Kanade, International Journal of Computer Vision, vol. 9, no. 2, pp. 137-154, 1992 or by using standard shape models prepared in advance. In this embodiment, a case where standard face shapes are used is presented as an example.

Next, a face orientation angle is obtained from a camera motion matrix. The camera motion matrix corresponds to a rotation matrix except for the scale thereof, and rotation in three directions can be obtained if the rotation matrix is known. However, since the camera motion matrix is a 3×2 matrix, it is necessary to complete the rotation matrix to obtain a 3×3 rotation matrix.

The rotation matrix is expressed by a 3×3 square matrix and has nine components. The rotation matrix has three degrees of freedom, and when some of the components are given, the rest of the components may be uniquely determined. In such case, all the components can be obtained by elementary calculation.

When six components in the upper two rows of the rotation matrix are given with errors contained, the following processes (1) to (4) are performed to complete the rotation matrix with the other three components in the lowermost row.

(1) Modify row vectors of the first and second rows so that norms thereof become “1” without changing the directions thereof.

(2) Modify only the directions of the row vector of the first row and the row vector of the second row so that a scalar product of the vectors becomes 0 without changing the lengths thereof. In this process, modification is made in a manner that the direction of the average vector of the two vectors does not change.

(3) Calculate a quaternion equivalent to the rotation matrix by using the six components in the upper two rows. A relational expression of the rotation matrix and the quaternion is described in “Three-dimensional Vision”, Gang Xu and Saburo Tsuji, (Kyoritsu Shuppan, 1998), p. 22, for example, and the quaternion can be obtained by using the relational expression through elementary calculation.

(4) Obtain components in the lowermost row of the rotation matrix by calculation again from the obtained quaternion using the relational expression of the rotation matrix and the quaternion. When the 3×3 rotation matrix is obtained in this manner, rotation angles of three axes can be obtained therefrom.

Assuming that the three rotation angles are an horizontal angle, a vertical angle and a tilt angle, a condition for determination may be that the respective angles are smaller than a predetermined threshold. The threshold may be 15 degrees, for example. In determination of the condition 3, the face is determined to be stationary when the average value, the maximum value or the like of the amounts of motion of feature points is smaller than a predetermined amount of motion, for example. A difference from a previous frame, for example, is used for the amount of motion.

In readiness determination, if the conditions are not satisfied, the conditions may be presented to the object person. For example, if the size of the face is smaller than a predetermined size, the state that “the face is too small” may be presented, or a prompt, such as “please get near to the camera”, to encourage the user to act so as to satisfy the condition may be presented. Examples of the method for presentation include displaying in a form of a text on a display, presenting with voice, and presenting by a change of light of an LED or the like. Furthermore, not only a result that a condition is not satisfied but also a result that a condition is satisfied may be presented. For example, a text such as “ready” may be presented. If there is a plurality of conditions, whether it is ready may be presented individually for each of the conditions.

The processes performed by the readiness determining unit 12 are as described above.

An initiation determining unit 13 determines that there is a change in the state of a face image in an image at different time from the image on which the determination is made by the readiness determining unit 12. More specifically, the initiation determining unit 13 determines a state to be an “initiation state” when the amount of motion of a detected feature point is larger than a set value. “Determination that a state is the initiation state” is referred to as “initiation determination”. Note that an amount of motion is a difference between coordinates of a feature point at the time when the readiness determination is completed and coordinates of the feature point at the time when the determination is made.

In the initiation determination, a prompt that encourages an action may be presented if the condition is not satisfied. In addition, it is desirable to return to the readiness determination again if the condition is still not satisfied after a lapse of a certain period of time.

A three-dimensionality determining unit 14 determines that an object in a captured image is three-dimensional (solid). The three-dimensionality determining unit 14 may use a method disclosed in JP-A 2007-304801 (KOKAI), for example. In JP-A 2007-304801 (KOKAI), facial feature points in two captured face images with different face orientations are detected, and it is determined whether the shape formed by the facial feature points is two-dimensional or three-dimensional. In this case, a face image in a state where the readiness determination is successful and a face image in a state where the initiation determination is successful may be used for the two face images. The facial feature points used here can be those already detected by the readiness determining unit 12 and the initiation determining unit 13.

A presenting unit 56 presents a message indicating that an input face image is not suitable for impersonation determination if the readiness determining unit 12 determines that the input face image is not in a state suitable for the impersonation determination. The presenting unit 56 may also present a message asking to input a new face image. The message can encourage an operator that performs face recognition to make an imaging unit, which is not illustrated, input a face image that satisfies the condition.

The presenting unit 56 also presents a message indicating that a face image is not suitable for the three-dimensionality determination if there is no motion in the face image input to the initiation determining unit 13 from the face image that is subjected to the readiness determination. The presenting unit 56 may also present a message asking to input a new face image. The message can encourage an operator that performs face recognition to make an imaging unit, which is not illustrated, input a face image that satisfies the condition.

Note that the presenting unit 56 may present a prompt to an operator that performs face recognition with voice, light or the like in addition to displaying a message on a display unit.

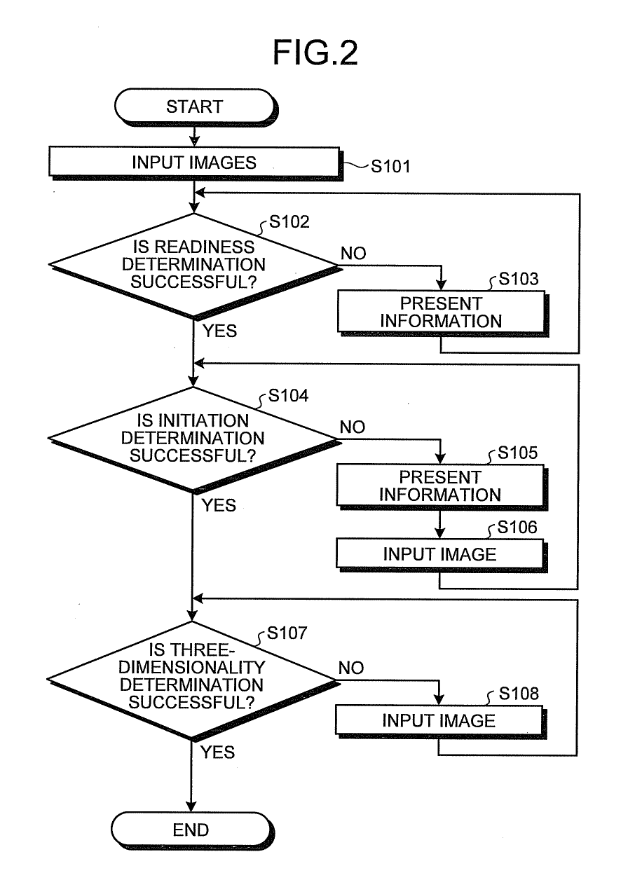

FIG. 2 is a flowchart illustrating an operation of the image processing device 10. In step S101 of FIG. 2, the image input unit 55, which will be described later, sequentially inputs images in time series. In step S102, the readiness determining unit 12 performs the readiness determination on a face image in the images in time series input by the image input unit 55. If the readiness determination is successful, the operation proceeds to step S104, or if the readiness determination is not successful, the operation proceeds to step S103.

In step S103, the presenting unit 56 presents a message or the like indicating that the face image is not suitable for the impersonation determination. After the process in step S103, the operation returns to step S102 and repeats the process therein.

In step S104, the initiation determining unit 13 performs the initiation determination on a face image at a different time from the face image subjected to the readiness determination. If the initiation determination is successful, the operation proceeds to step S107, or if the initiation determination is not successful, the operation proceeds to step S105.

In step S105, the presenting unit 56 presents a message or the like indicating that the face image is not suitable for the three-dimensionality determination. An image at different time is input from the image input unit 55 in step S106, and the operation returns to step S104 and repeats the process therein.

In step S107, the three-dimensionality determining unit 14 performs the three-dimensionality determination. If the three-dimensionality determination is successful, the process is terminated. If, in contrast, the three-dimensionality determination is not successful, the operation proceeds to step S108, where a new image is obtained. After step S108, the operation proceeds to step S107 and repeats the process therein.

Note that, when the three-dimensionality determination is not successful in step S107, the operation may return to step S101 and repeat the processes.

With the image processing device 10 according to the first embodiment, the readiness determining unit 12 determines that a subject person is in a state suitable for impersonation determination, and the initiation determining unit 13 further determines that there is a change from the ready state, whereby the three-dimensionality determining unit 14 that follows can obtain a state suitable for determination and it is thus possible to reduce false-positive determination in the impersonation determination.

### Second Embodiment

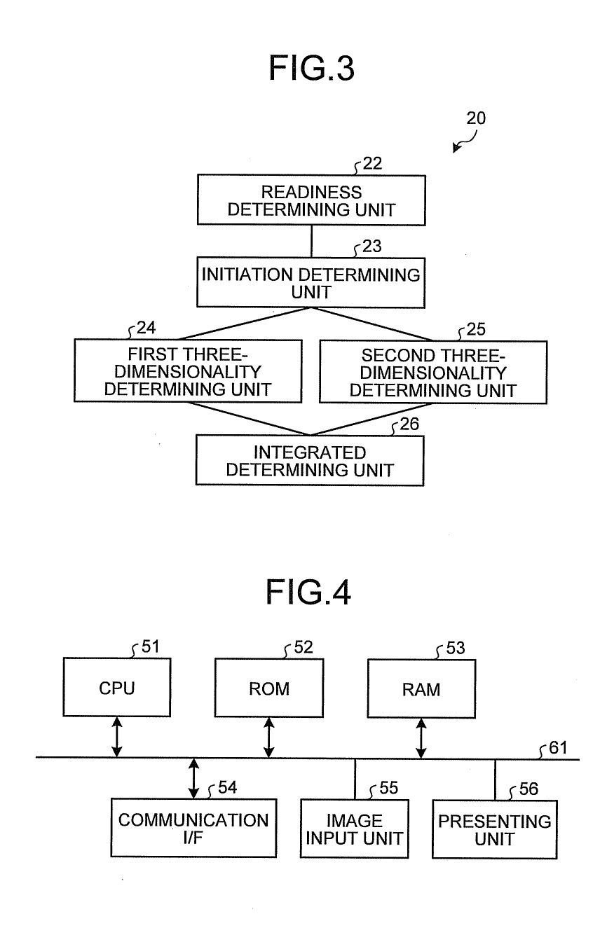

FIG. 3 is a block diagram illustrating a configuration of an image processing device 20 according to a second embodiment. The image processing device 20 includes a second three-dimensionality determining unit and an integrated determining unit in addition to the configuration of the image processing device 10 of the first embodiment.

In the first embodiment, the impersonation determination is performed by the single three-dimensionality determining unit 14. In the second embodiment, the accuracy is further improved by combining a plurality of methods having different properties.

In the image processing device 20, processes performed by an image input unit 55, a readiness determining unit 22, an initiation determining unit 23 and a presenting unit 56 are similar to those performed by the image input unit 55, the readiness determining unit 12, the initiation determining unit 13 and the presenting unit 56 in the image processing device 10. When the determinations in the processes are successful, a first three-dimensionality determining unit 24 and a second three-dimensionality determining unit 25 individually perform processes of three-dimensionality determination.

For example, the first three-dimensionality determining unit 24 performs determination by the same method as in the first embodiment.

In the second three-dimensionality determining unit 25, a method using detection of a change in normalized images of a face, for example, is used. Normalized images of a face are face images whose sizes and orientations are conformed to a certain size and orientation by using coordinates of detected feature points. For example, the images are normalized by affine transformation using coordinates of three points including two center points of pupils and the midpoint of nostrils. As a result of such normalization, similar normalized images are obtained in the case where the subject is a photograph captured with any imaging method, but a change in the normalized images can be obtained in the case where the subject is an actual human face due to variation in the orientation or variation of illumination.

Accordingly, a plurality of such normalized images is obtained, the degrees of similarity between an average image thereof and each of the normalized images are obtained by normalized correlation, for example, and it is determined that the subject is three-dimensional if the degrees of similarity exceed a set value. In this case, a more stable average image can be obtained by using an average image at the time of the readiness determination.

An integrated determining unit 26 performs determination in an integrated manner based on the determination results for each frame in the first and second three-dimensionality determining units. The first three-dimensionality determining unit 24 and the second three-dimensionality determining unit 25 use different methods for determination. In the example described above, for example, the first three-dimensionality determining unit 24 performs determination based on relative positions of coordinates of the feature points, while the second three-dimensionality determining unit 25 performs three-dimensionality determination based on variation in the normalized images. Accordingly, either one of the three-dimensionality determining units may complete the determination earlier or only one of the three-dimensionality determining units may be able to perform determination in some cases depending on the input face image.

Therefore, the integrated determining unit 26 outputs a determination result that the face in the face image is three-dimensional if it is determined to be three-dimensional by either one of the three-dimensionality determining units. On the other hand, the integrated determining unit 26 determines that the face is not three-dimensional if frames that are determined to be three-dimensional by neither of the three-dimensionality determining units continue for a certain period.

As described above, with the image processing device 20 according to the second embodiment, two different types of three-dimensionality determining units compensate for disadvantages of each other, whereby impersonation that is not able to be determined by either one of the three-dimensionality determining units can be determined, and it is thus possible to reduce false-positive determination in the impersonation determination. Moreover, since the determination result is output at a time when either one three-dimensionality determining unit produces a determination result at the earlier timing of determination, it is possible to perform determination in a shorter time than in the case where a single three-dimensionality determining unit is used, and the waiting time of the user can be shortened.

FIG. 4 is a diagram illustrating a hardware configuration of a computer system including the image processing device according to the embodiments.

The image input unit 55 is configured to sequentially input time-series images. Images that are captured at two or more times, for example, may be input as the input images instead of time series images. A CPU 51 controls respective components of the computer system. Storage units such as a ROM 52 and a RAM 53 store programs, data and the like. A communication I/F 54 is connected to a network in a manner capable of communication. A bus 61 connects the components enabling communication therebetween.

The CPU 51 reads and executes the programs stored in the storage media such as the ROM 52. As a result, the functions of the respective units of the image processing device according to the embodiments described above are implemented by the computer system.

The programs to be executed in the image processing device can be embedded in the ROM 52 or the like and provided therefrom.

The programs to be executed in the image processing device can be recorded on a computer readable recording medium such as a CD-ROM, a flexible disk (FD), a CD-R and a DVD in a form of a file that can be installed or executed, and provided therefrom.

Alternatively, the programs to be executed in the image processing device may be stored in a storage medium connected to a network such as the Internet, and provided via a transmission medium such as a network.

Although the amounts of motion of the feature points are used for motion determination in the first and second embodiments, the motion determination is not limited thereto. For example, a change amount of the face orientation obtained for determination of the condition 2 in the readiness determination may be obtained. In this case, it is desirable to use a horizontal or vertical angle that is effective for the three-dimensionality determination as the rotation direction of the face orientation.

The conditions for the determination performed by the readiness determining unit 12 and the readiness determining unit 22 are not limited to those in the embodiments above. Other conditions such as a condition that an image is not blurred as a result of determination whether or not the image is blurred may be used.

The number of the three-dimensionality determining units in the second embodiment is not limited to two. The number thereof may be more than two. In addition, the three-dimensionality determining units in the first and second embodiments are not limited thereto and may use other methods. Furthermore, means for performing biometric determination instead of the three-dimensionality determination may be used.

Although affine transformation using three points is used to obtain the normalized images in the second three-dimensionality determining unit 25 in the second embodiment, the normalization is not limited thereto. Any method that can normalize any one of the position, the size and the orientation may be used.

In the second embodiment, the integrated determining unit 26 determines that an image is three-dimensional if either one of the first three-dimensionality determining unit 24 and the second three-dimensionality determining unit 25 determines that the image is three-dimensional, but the determination is not limited thereto. Other determining methods may be employed. For example, a score of likelihood of three-dimensionality may be output for each frame by each determining unit and determination may be made in an integrated manner based on the values thereof. For example, an image may be determined to be three dimensional if a sum of the scores exceeds a predetermined threshold.

The method for obtaining the size, the orientation and the amount of motion of a face used in the readiness determining unit 12 and the readiness determining unit 22 does not have to be the method using facial feature points. For example, these may be obtained by detecting a face region.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing device comprising:
a readiness determining unit configured to determine whether or not a state of a face image included in an image at one time out of images obtained at a plurality of different times is a ready state that satisfies a condition for performing three-dimensionality determination, three-dimensionality determination is determining whether the object is three-dimensional or not;
an initiation determining unit configured to determine whether or not a state of a face image included in an image at different time from the image at the one time is an initiation state changed from the ready state; and
a first three-dimensionality determining unit configured to perform the three-dimensionality determination on the face images included in the images when it is determined that the state is the initiation state.

2. The device according to claim 1, wherein the ready state is a state in which the face images are stationary in the images.

3. The device according to claim 2, wherein the initiation determining unit determines that the state is the initiation state when there is a motion in the face image from the face image in the ready state.

4. The device according to claim 3, wherein in the ready state, a face size, a face orientation and a face motion amount in the face image are within set ranges.

5. The device according to claim 4, comprising:
at least one second three-dimensionality determining unit different from the first three-dimensionality determining unit; and
an integrated determining unit configured to determine that the face image is three-dimensional when one of the first three-dimensionality determining unit and the second three-dimensionality determining unit determines that the face image is three-dimensional.

6. An image processing method comprising:
determining, whether or not a state of a face image included in an image at one time out of images obtained at a plurality of different times is a ready state that satisfies a condition for performing three-dimensionality determination;
determining, whether or not a state of a face image included in an image at different time from the image at the one time is an initiation state changed from the ready state; and
performing, the three-dimensionality determination on the face images included in the images when it is determined that the state is the initiation state.

7. A computer program product comprising a computer readable medium including programmed instructions, wherein the instructions, when executed by a computer, cause the computer to perform:
determining whether or not a state of a face image included in an image at one time out of images obtained at a plurality of different times is a ready state that satisfies a condition for performing three-dimensionality determination;
determining whether or not a state of a face image included in an image at different time from the image at the one time is an initiation state changed from the ready state; and
performing the three-dimensionality determination on the face images included in the images when it is determined that the state is the initiation state.
